(19) United States
(12) Patent Application Publication
(10) Pub. No.: US 2026/0245858 A1
(43) Pub. Date: Aug. 20, 2026

(54) ADJUSTABLE ELECTRODE LOCALIZED ELONGATION

(71) Applicant: GM GLOBAL TECHNOLOGY OPERATIONS LLC, Detroit, MI (US)

(72) Inventors: Raghavendra Keerthi MANDA, Northville, MI (US); Melissa STANDING-BALL, New Boston, MI (US); David F. TITMUSS, Commerce Township, MI (US); Daniel Gerardo GONZALEZ, Lake Orion, MI (US)

(21) Appl. No.: 19/057,237

(22) Filed: Feb. 19, 2025

(51) Int. Cl. H01M 4/04; H01M 4/1395

(52) U.S. Cl. CPC H01M 4/0435; H01M 4/1395

(57) ABSTRACT

A roll-to-roll system for manufacturing electrodes for a battery cell includes an idle roller and T tension rings arranged around an outer surface of the idle roller. The T tension rings are spaced from one another in an axial direction. The T tension rings are arranged at least one of between active material layers arranged on a current collector and at outer edges of the current collector radially outside of the active material layers. An inflatable sleeve is arranged around the idle roller and the T tension rings. The inflatable sleeve is made of a material selected from a group consisting of rubber, polyurethane, elastic polymer, and combinations thereof. First and second end supports are arranged in opposite axial ends of the idle roller. First and second shafts extend from the first and second end supports. A valve is arranged between the pressurized gas source and the inflatable sleeve.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to systems and methods for roll-to-roll manufacturing of electrodes for battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector. Roll-to-roll processing may be used to manufacture the cathode and anode electrodes. Manufacturing of electrodes using roll-to-roll processing is challenging.

### SUMMARY

A roll-to-roll system for manufacturing electrodes for a battery cell including an idle roller and T tension rings arranged around an outer surface of the idle roller where T is an integer greater than one. The T tension rings are spaced from one another in an axial direction. An inflatable sleeve is arranged around the idle roller and the T tension rings.

In other features, first and second end supports are arranged in opposite axial ends of the idle roller. First and second shafts extend from the first and second end supports. The end supports include bearings including an outer race in contact with the idle roller and an inner race in contact with the shaft. The tension rings are arranged at least one of between active material layers arranged on a current collector and outer edges of the current collector.

In other features, the roll-to-roll system includes a pressurized gas source. A valve is arranged between the pressurized gas source and the inflatable sleeve. A controller is configured to control the valve to supply pressurized gas from the pressurized gas source to the inflatable sleeve.

In other features, first and second axial adjusters are configured to adjust locations of first and second ones of the T tension rings in an axial direction. The first and second axial adjusters include first and second threaded rods. The idle roller includes T axial slots and wherein the T tension rings move axially within the T axial slots.

In other features, the T tension rings include bearings arranged between the T tension rings and an outer diameter of the idle roller. The inflatable sleeve is made of a material selected from a group consisting of rubber, polyurethane, elastic polymer, and combinations thereof. T is equal to 2. T is greater than 2.

A roll-to-roll system for manufacturing electrodes for a battery cell includes an idle roller including a cylindrical member, N raised cylindrical portions arranged on the roller and extending radially outwardly therefrom, where N is an integer greater than zero, G gaps are located at least one of on opposite axial ends of at least two of the N raised cylindrical portions and between the N raised cylindrical portions when N is greater than one, and a nip roller arranged adjacent to the idle roller. A continuous electrode includes N lanes of an active material layer arranged on a current collector. The continuous electrode passes between the nip roller and the idle roller. A positioning device is configured to vary contact between the nip roller and the idle roller.

In other features, N is greater than one and the N raised cylindrical portions have an axial width based on axial widths of the N lanes. At least one of the G gaps has axial width based on a gap between the N lanes. The positioning device is configured to move the nip roller in a radial direction relative to the idle roller. The positioning device is configured to move the nip roller in an axial direction relative to the idle roller.

A roll-to-roll system for manufacturing electrodes for a battery cell includes an idle roller and T tension rings arranged around an outer surface of the idle roller, wherein T is an integer greater than one. The T tension rings are spaced from one another in an axial direction. The T tension rings are arranged at least one of between active material layers arranged on a current collector and at outer edges of the current collector radially outside of the active material layers. An inflatable sleeve is arranged around the idle roller and the T tension rings. The inflatable sleeve is made of a material selected from a group consisting of rubber, polyurethane, elastic polymer, and combinations thereof. First and second end supports are arranged in opposite axial ends of the idle roller. First and second shafts extend from the first and second end supports. A valve is arranged between the pressurized gas source and the inflatable sleeve. A controller is configured to control the valve to supply pressurized gas from the pressurized gas source to the inflatable sleeve.

In other features, first and second axial adjusters configured to adjust locations of first and second ones of the T tension rings in an axial direction. The first and second axial adjusters include first and second threaded rods. The idle roller includes T axial slots. The T tension rings move axially within the T axial slots. The T tension rings include bearings arranged between the T tension rings and an outer diameter of the idle roller.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a side cross section of an example of a battery cell including A anode electrodes, C cathode electrodes, and S separators according to the present disclosure;

FIG. 1B is an example of a continuous electrode made using a roll-to-roll process;

FIG. 2A is an exploded view of an example of an idle roller according to the present disclosure;

FIGS. 2B to 2D are side cross sections of the roller of FIG. 2A in different modes according to the present disclosure;

FIG. 3A is a flowchart of an example of a method for operating the roller according to the present disclosure;

FIG. 3B is a functional block diagram of an example of a controller configured to adjust a mode of the roller according to the present disclosure;

FIG. 4 is a side view of an example of a roller and a nip roller according to the present disclosure;

FIG. 5 is a side view of an example of a roll-to-roll system including the roller and nip roller of FIG. 4;

FIG. 6 is a flowchart of an example of a method for operating the roller according to the present disclosure;

FIGS. 7A and 7B are side views illustrating adjustment of the dancer according to the present disclosure;

FIG. 8A is a side view illustrating an example of a roller with telescoping rings according to the present disclosure; and

FIGS. 8B and 8C are side cross sections illustrating an example of a roller with telescoping rings according to the present disclosure.

In the drawings, reference numbers may be reused to identify similar and/or identical elements.

### DETAILED DESCRIPTION

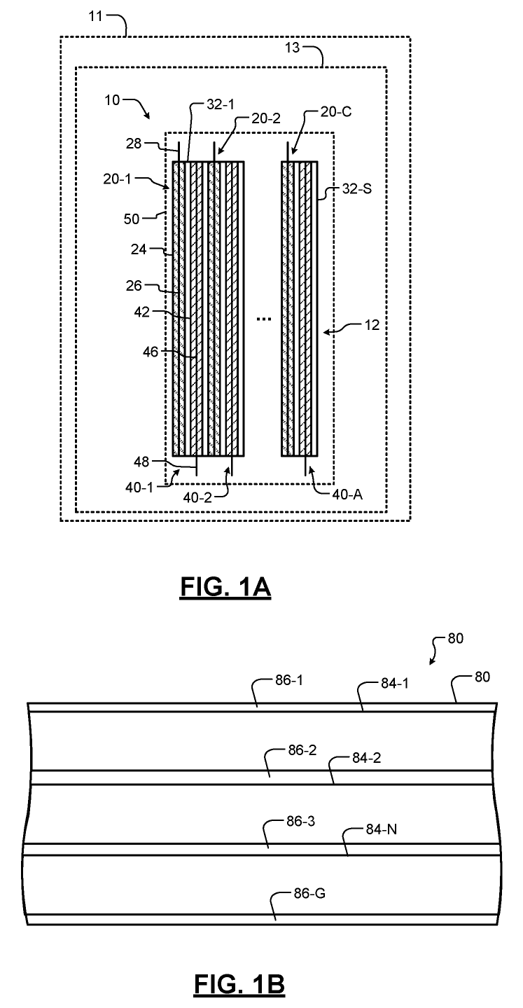

Referring now to FIG. 1A, a battery cell 10 includes C cathode electrodes 20, A anode electrodes 40, and S separators 32 arranged in a predetermined sequence in a battery cell stack 12, where C, S and A are integers greater than zero. In some examples, the vehicle 11 includes a battery module or pack 13 including the battery cell 10. The battery cell stack 12 is arranged in an enclosure 50 (e.g., a prismatic, cylindrical, or pouch enclosure).

The C cathode electrodes 20-1, 20-2, …, and 20-C include cathode active material layers 24 arranged on one or both sides of a cathode current collector 26. The A anode electrodes 40-1, 40-2, ..., and 40-A include anode active material layers 42 arranged one or both sides of an anode current collector 46. During charging/discharging, the A anode electrodes 40 and the C cathode electrodes 20 exchange lithium ions.

In some examples, the anode current collectors 46 and/or the cathode current collectors 26 comprise metal foil, metal mesh, perforated metal, 3 dimensional (3D) metal foam, and/or expanded metal. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

In some examples, the anode and/or cathode electrodes are manufactured using a roll-to-roll process. The cathode active material layers 24 and/or the anode active material layer 44 comprise coatings including one or more active materials, one or more conductive additives, and/or one or more binder materials that are cast or applied onto the current collectors and then pressed and/or heated between rollers. For example, a slurry including a solvent and the one or more active materials, one or more conductive additives, and/or one or more binder materials are coated onto the current collector, dried to remove the solvent, and then calendered. Alternately, a dry mixture without the solvent can be used. In some examples, multiple electrodes are cast or applied at the same time in adjacent lengthwise lanes to increase output. Spaces between the lanes and outer edges of the current collector do not include the active material layer.

Calendering of the electrode involves applying a compressive force to increase the density of the active material layer of the electrode. The compressive force is only applied to the regions including the active material layer. The spaces between the lanes and outer edges of the current collector do not experience the same level of compressive force due to their different thicknesses. Wrinkling of the current collector in these areas (e.g., between the lanes and outer edges) may occur after the calendering process, especially during continuous coating.

The present disclosure relates to systems and methods for significantly reducing post-calendering electrode wrinkling (e.g., between the lanes and outer edges) by applying properly aligned tension in these areas before the calendering process.

Referring now to FIG. 1B, a continuous electrode 70 (such as an anode or cathode electrode) includes a current collector 80, N lanes 84-1, 84-2, …, and 84-N including a coating including an active material layer, and G gaps located between the N lanes 84-1, 84-2, …, and 84-N and at radially outer edges of the continuous electrode 70. After calendaring, the continuous electrode 70 is cut into discrete electrodes.

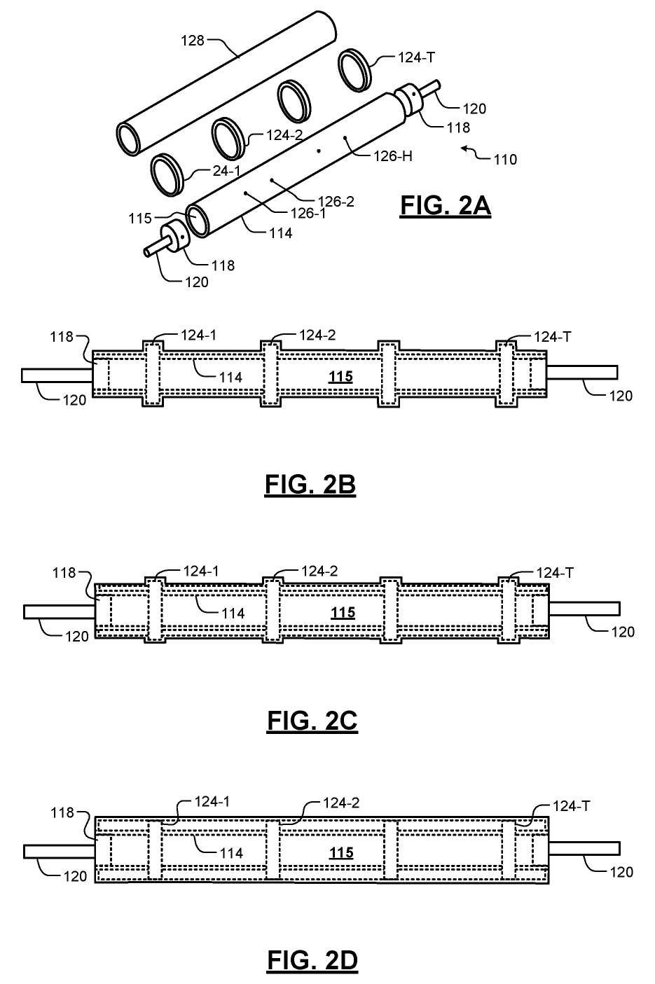

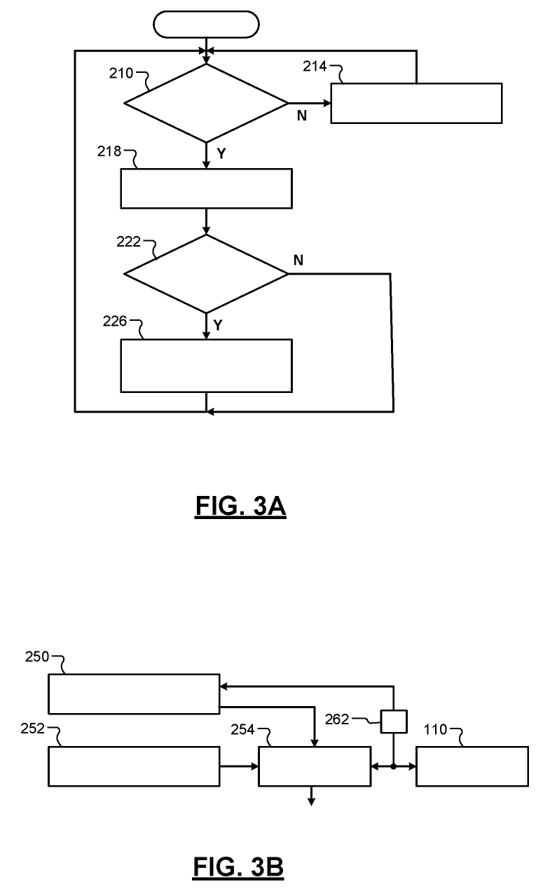

Referring now to FIG. 2A, an adjustable roller 110 is shown to include an idle roller 114 having a cylindrical shape defining a cylindrical cavity 115. Cylindrical end supports 118 are arranged in opposite ends of the cylindrical cavity 115 of the idle roller 114. Shafts 120 extend from cylindrical end supports 118. In some examples, the cylindrical end supports 118 include bearings with outer races in contact with an inner diameter of the idle roller 114 and inner races in contact with the shafts 120. In some examples, the shafts 120 do not rotate.

T tension rings 124-1, 124-2, …, and 124-T (collectively tension rings 124) have an annular shape and are arranged around an outer circumference of the idle roller 114 at different axial locations, where T is an integer greater than zero. In some examples, the tension rings 124 are aligned with the gaps between the lanes and/or at outer edges of the continuous current collector.

An inflatable sleeve 128 is arranged over the idle roller 114 and the tension rings 124. In some examples, the inflatable sleeve 128 is made of a flexible material such as rubber, polyurethane, elastic polymer, and combinations thereof. In some examples, the inflatable sleeve 128 is built into the idle roller 114. In some examples, the inflatable sleeve 128 includes a single layer that is clamped at axial ends of the idle roller 114 to form a seal with an outer surface of the idle roller 114. In some examples, the inflatable sleeve 128 includes inner and outer layers defining an inflatable air chamber therebetween. In some examples, the inflatable sleeve 128 is compression fit to the idle roller 114.

In some examples, pressurized air is supplied to the cylindrical cavity 115 and passes through holes 126-1, 126-2, …, and 126-H in the cylindrical cavity 115 to selectively inflate the inflatable sleeve 128 to vary a diameter of the adjustable roller 110 relative to the tension rings 124, where H is an integer greater than zero. The variable diameter can be used to adjust tension in these locations.

Referring now to FIGS. 2B to 2D, different modes of the adjustable roller 110 are shown. In FIG. 2B, the inflatable sleeve 128 is not inflated. The tension rings 214 extend radially outwardly above a cylindrical surface of the adjustable roller 110 as compared to other locations thereof. In FIG. 2C, the inflatable sleeve 128 is partially inflated. The tension rings 214 extend radially outwardly above an outer cylindrical surface of the adjustable roller 110 (to a lesser extent as compared to FIG. 2B). In FIG. 2D, the inflatable sleeve 128 is inflated such that the outer surface of the inflatable sleeve 128 is higher than or at the same level as outer diameters of the tension rings 124. The inflatable sleeve 128 extends radially outwardly above the tension rings 124.

Referring now to FIG. 3A, a method for operating the adjustable roller 110 is shown. At 210, the method determines whether elongation is required. If 210 is false, the method inflates the roller at 214 (e.g., as shown in FIG. 2D). If 210 is false, the method deflates inflatable sleeve 128 at 218. At 222, the method determines whether more precise control is required. If 222 is true, the method adjusts the pressure in the inflatable sleeve 128 to change the diameter between fully inflated and fully deflated (e.g., as shown in FIGS. 2B and 2C).

Referring now to FIG. 3B, a controller 250 is configured to adjust a mode of the adjustable roller 110. The controller 250 is configured to control or adjust a valve to increase or decrease pressure supplied to the adjustable roller 110. For example, the valve 254 supplies pressurized gas (e.g., air) from a pressurized gas source 252 to the adjustable roller 110 to increase pressure. For example, the valve 254 releases pressurized gas from the adjustable roller 110 to decrease pressure. In some examples, the controller receives a pressure measurement from a pressure sensor 262 monitoring pressure in the inflatable sleeve and performs control based thereon.

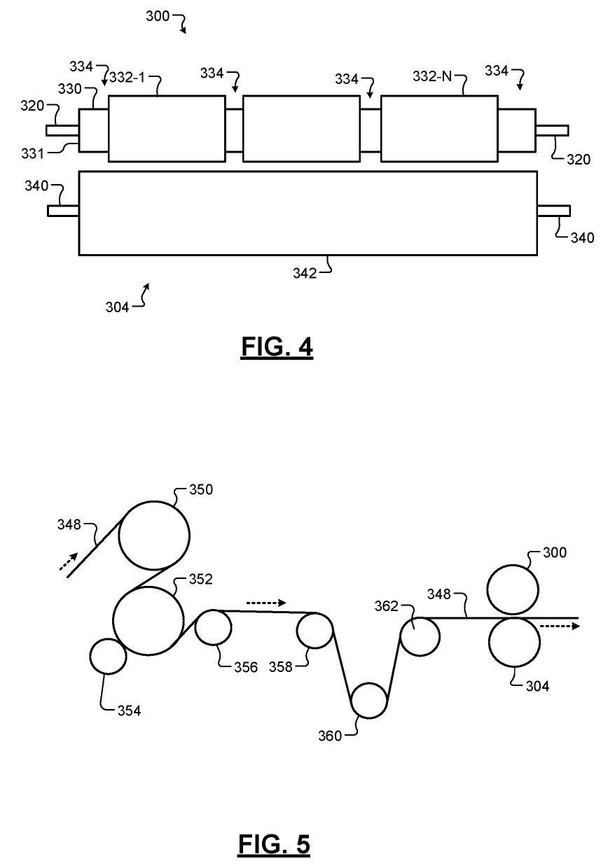

Referring now to FIG. 4, side views of a roller 300 and a nip roller 304 are shown. A roller 330 includes a cylindrical member 331 and shafts 320 extending from opposite sides thereof. Raised cylindrical portions 332-1, 332-2, …, and 332-N are arranged on the roller and extend radially outwardly therefrom. Gaps 334 are located between the raised cylindrical portions 332-1, 332-2, …, and 332-N. In some examples, the gaps 334 correspond to the lanes between the active material layers or gaps at the outer edges. The nip roller 304 includes shafts 340 and a cylindrical surface 342 arranged therebetween.

Referring now to FIG. 5, a roll-to-roll system including the roller and nip roller of FIG. 4 is shown. A continuous electrode 348 passes over roller 350 and between roller 352 and a nip roller 354 that optionally pre-heats the continuous electrode 348. The continuous electrode 348 passes over rollers 356 and 358, a dancer 360, and a roller 362 before passing between the roller 300 and the nip roller 304. The position of the nip roller 304 is varied to adjust tension.

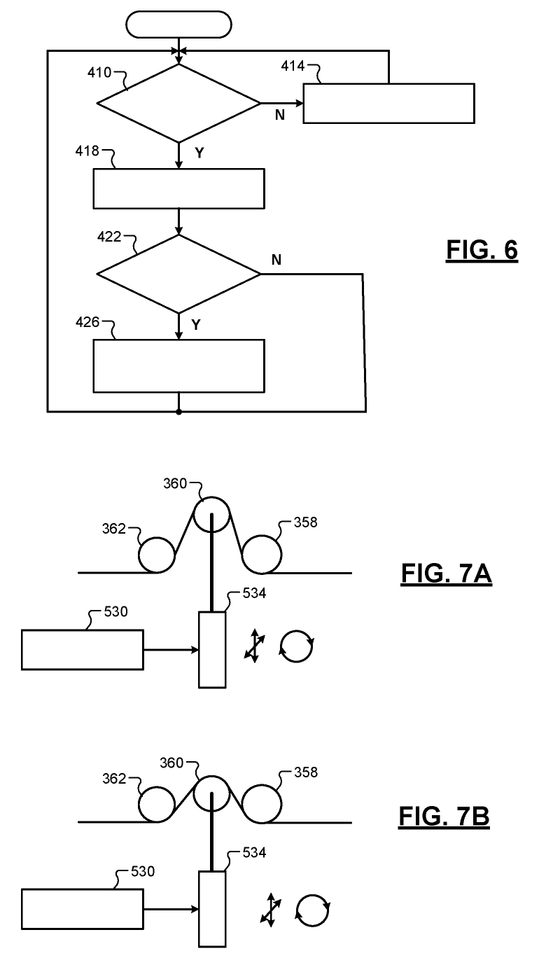

Referring now to FIG. 6, a method for operating the roller and nip roller of FIGS. 4 and 5 is shown. At 410, the method determines whether elongation is required. If 410 is false, the method opens the nip roller at 414. If 410 is false, the method closes the nip roller at 418. At 422, the method determines whether precise control is required. If 422 is true, the method adjusts the dancer 360 to control elongation.

Referring now to FIGS. 7A and 7B, adjustment of the dancer 360 is shown. The dancer 360 can be adjusted linearly (up and down), axially (in and out of the page including FIGS. 7A and 7B), or rotationally to adjust the tension on the electrode. A controller 530 is configured to control a positioning device (PD) to adjust at least one of the linear or axial position and/or rotation of the dancer 360 to affect elongation of the electrode. Varying linear position of the dancer 360 can be used to increase or decrease wrap angle, which can be used to vary elongation.

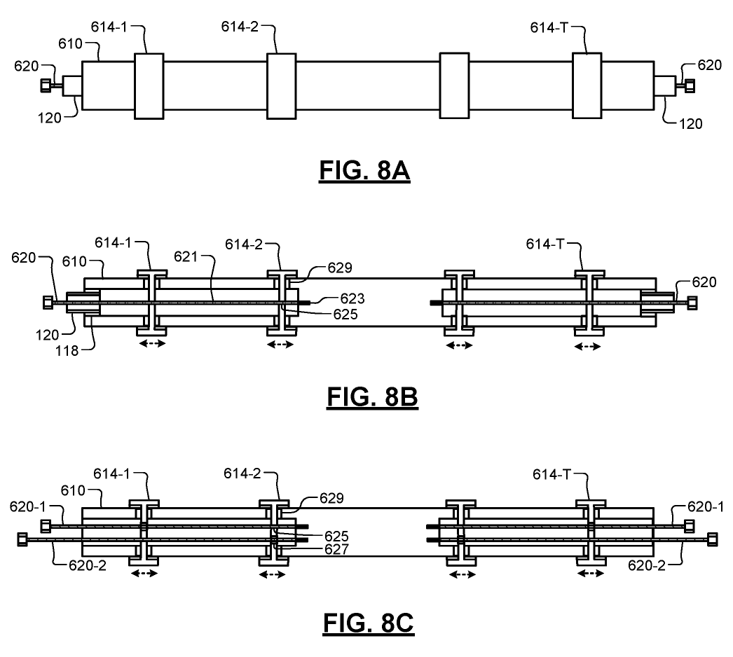

Referring now to FIGS. 8A to 8C, tension rings 614-1, 614-2, …, and 614-T telescope in an axial direction to allow adjustment of lanes between active material layers, where T is an integer greater than zero. In FIGS. 8A and 8B, the tension rings 614-1, 614-2, …, and 614-T (tension rings 614) are arranged around an outer circumference of a roller 610 and include an outer annular portion and at least one inner portion extending radially between the outer annular portion. In this example, the T tension rings 614 are adjusted in an axial direction using one or more axial tension ring adjusters 620. In some examples, the one or more axial tension ring adjusters 620 include a threaded rod 621 that includes an inner end 623 rotatably attached inside of the roller 610. The threads of the threaded rod 621 mate with threaded bores 625 on the tension rings 614. As the axial tension ring adjuster 620 is rotated, the tension rings 614 to move axially inwardly or outwardly. The roller 610 includes axial slots 629 to allow the tension rings 614 to move axially. In FIG. 8C, more than one axial adjuster 620-1 and 620-2 can be used at each axial end to individually adjust the tension rings 614 on each side separately. Bores 627 on the inner portion of the T tension rings provide clearance to one of the axial adjuster 620-1 to allow independent adjustment.

In some examples, the tension rings have an axial width in a range from 10 to 40mm, although other widths can be used. In some examples, the tension rings have an axial width in a range from 20 to 30mm. In some examples, the axial slot has an axial width less than one-half of a width of the tension rings, although other widths can be used. In some examples, the axial slot has an axial width in a range from 0.1 mm to 1 mm. In some examples, the axial slot has an axial width in a range from 0.2 mm to 0.5 mm. In some examples, the axial adjusters allow axial adjustment of the tension rings with micrometer resolution.

The roll-to-roll systems described herein allow on the fly adjustment to improve the sensitivity of localized elongation. The roll-to-roll systems enable adjustment of the wrap angle to proactively match the post calendering stain difference. The roll-to-roll systems allow roller dimension changes using air pressure to provide precise control over the elongation of the current collector. The roller can be designed for edge coated material and/or continuous electrodes including multiple lanes. In addition to the inline elongation system, this system has the capability to automate elongation, thereby reducing the occurrence of wrinkling.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A roll-to-roll system for manufacturing electrodes for a battery cell, comprising:
an idle roller;
T tension rings arranged around an outer surface of the idle roller,
wherein T is an integer greater than one,
wherein the T tension rings are spaced from one another in an axial direction; and
an inflatable sleeve arranged around the idle roller and the T tension rings.

2. The roll-to-roll system of claim 1, further comprising:
first and second end supports arranged in opposite axial ends of the idle roller; and
first and second shafts extending from the first and second end supports.

3. The roll-to-roll system of claim 2, wherein the end supports include bearings including an outer race in contact with the idle roller and an inner race in contact with the shaft.

4. The roll-to-roll system of claim 1, wherein the tension rings are arranged at least one of between active material layers arranged on a current collector and outer edges of the current collector.

5. The roll-to-roll system of claim 1, further comprising:
a pressurized gas source;
a valve arranged between the pressurized gas source and the inflatable sleeve; and
a controller configured to control the valve to supply pressurized gas from the pressurized gas source to the inflatable sleeve.

6. The roll-to-roll system of claim 1, further comprising:
first and second axial adjusters configured to adjust locations of first and second ones of the T tension rings in an axial direction.

7. The roll-to-roll system of claim 6, wherein the first and second axial adjusters include first and second threaded rods.

8. The roll-to-roll system of claim 6, wherein the idle roller includes T axial slots and wherein the T tension rings move axially within the T axial slots.

9. The roll-to-roll system of claim 6, wherein the T tension rings include bearings arranged between the T tension rings and an outer diameter of the idle roller.

10. The roll-to-roll system of claim 6, wherein the inflatable sleeve is made of a material selected from a group consisting of rubber, polyurethane, elastic polymer, and combinations thereof.

11. The roll-to-roll system of claim 1, wherein T is equal to 2.

12. The roll-to-roll system of claim 1, wherein T is greater than 2.

13. A roll-to-roll system for manufacturing electrodes for a battery cell, comprising:
an idle roller including:
a cylindrical member;
N raised cylindrical portions arranged on the roller and extending radially outwardly therefrom, where N is an integer greater than zero;
G gaps are located at least one of:
on opposite axial ends of at least two of the N raised cylindrical portions; and
between the N raised cylindrical portions when N is greater than one;
a nip roller arranged adjacent to the idle roller,
wherein a continuous electrode includes N lanes of an active material layer arranged on a current collector and wherein the continuous electrode passes between the nip roller and the idle roller; and
a positioning device configured to vary contact between the nip roller and the idle roller.

14. The roll-to-roll system of claim 13, wherein N is greater than one and wherein the N raised cylindrical portions have an axial width based on axial widths of the N lanes.

15. The roll-to-roll system of claim 13, wherein at least one of the G gaps has axial width based on a gap between the N lanes.

16. The roll-to-roll system of claim 13, wherein the positioning device is configured to move the nip roller in a radial direction relative to the idle roller.

17. The roll-to-roll system of claim 13, wherein the positioning device is configured to move the nip roller in an axial direction relative to the idle roller.

18. A roll-to-roll system for manufacturing electrodes for a battery cell, comprising:
an idle roller;
T tension rings arranged around an outer surface of the idle roller,
wherein T is an integer greater than one, the T tension rings are spaced from one another in an axial direction, and the T tension rings are arranged at least one of between active material layers arranged on a current collector and at outer edges of the current collector radially outside of the active material layers;
an inflatable sleeve arranged around the idle roller and the T tension rings, wherein the inflatable sleeve is made of a material selected from a group consisting of rubber, polyurethane, elastic polymer, and combinations thereof;
first and second end supports arranged in opposite axial ends of the idle roller;
first and second shafts extending from the first and second end supports;
a pressurized gas source;
a valve arranged between the pressurized gas source and the inflatable sleeve; and
a controller configured to control the valve to supply pressurized gas from the pressurized gas source to the inflatable sleeve.

19. The roll-to-roll system of claim 18, further comprising:
first and second axial adjusters configured to adjust locations of first and second ones of the T tension rings in an axial direction,
wherein the first and second axial adjusters include first and second threaded rods,
wherein the idle roller includes T axial slots and wherein the T tension rings move axially within the T axial slots.

20. The roll-to-roll system of claim 18, wherein the T tension rings include bearings arranged between the T tension rings and an outer diameter of the idle roller.
